(19) United States
(12) Patent Application Publication
(10) Pub. No.: US 2026/0142177 A1
(43) Pub. Date: May 21, 2026

(54) NON-FLUORINATED SECONDARY BATTERY

(71) Applicant: Hansol Chemical Co., Ltd., Seoul (KR)

(72) Inventors: Hoon-Moh SEONG, Iksan-si (KR); Kwang-In KIM, Iksan-si (KR); Nam-Sun YOON, Iksan-si (KR); So-Jeong LEE, Iksan-si (KR); Hee-Jeong KIM, Iksan-si (KR); Su-Hyeon AN, Iksan-si (KR); Se-Man KWON, Wanju (KR)

(21) Appl. No.: 19/290,733

(22) Filed: Aug. 5, 2025

(30) Foreign Application Priority Data
Nov. 20, 2024 (KR) 10-2024-166091
May 22, 2025 (KR) 10-2025-0066646

(51) Int. Cl. H01M 4/62; H01M 4/02; H01M 10/0567; H01M 10/0568; H01M 10/0569

(52) U.S. Cl. CPC H01M 4/622; H01M 10/0567; H01M 10/0568; H01M 10/0569; H01M 2004/027; H01M 2004/028; H01M 2300/004

(57) ABSTRACT

Proposed is a non-fluorinated secondary battery including a positive electrode capable of storing and releasing metal ions, a negative electrode capable of storing and releasing metal ions, a non-aqueous electrolyte solution comprising a non-aqueous solution and an electrolyte dissolved in the non-aqueous solution, and a separator, wherein the positive electrode, the negative electrode, the non-aqueous electrolyte solution, and the separator are free of fluorine atoms.

### CROSS REFERENCE TO RELATED APPLICATION

This application claims the benefit of Korean Patent Application No. 10-2024-0166091, filed 20 Nov. 2024, and Korean Patent Application No. 10-2025-0066646, filed 22 May 2025, which is hereby incorporated by reference in its entirety into this application.

### BACKGROUND OF THE INVENTION

### 1. Technical Field

The present disclosure relates to a non-fluorinated secondary battery free of fluorine atoms.

### 2. Description of the Related Art

With high energy density, lithium secondary batteries are being used extensively in electrical, electronic, telecommunication, and computer fields. In addition, application fields of lithium secondary batteries are being expanded to high-capacity secondary batteries for hybrid vehicles, electric vehicles, and the like, in addition to small lithium secondary batteries for portable electronic devices.

Currently, numerous fluorine-containing compounds (for example, per- and polyfluoroalkyl substances (PFAS) and the like) are used in secondary batteries. Fluorine-containing compounds with excellent thermal stability and chemical resistance are regarded as necessities for high-voltage operation of batteries.

However, fluorine-containing compounds have recently been considered persistent organic pollutants due to bioaccumulation and toxicity, raising concerns about the impacts thereof on the environment and health. With the expectation of strict environmental regulations on fluorine-containing compounds to be applied, there is a demand for the exclusion of fluorine-containing compounds for use even in the development of secondary batteries. Additionally, fluorine-containing compounds result in the degradation of secondary battery performance.

For example, poly(vinylidene fluoride) (PVDF) binders and lithium hexafluorophosphate (LiPF₆) salts, which are fluorine-containing compounds, are widely applied to secondary batteries as binders for positive electrodes and electrolytes, respectively.

Hydrophobic PVDF interacts with an aluminum (Al) current collector and the surface of hydrophilic positive electrode active material particles through weak van der Waals forces, which may cause detachment of the active material from the current collector and severe erosion of the Al foil exposed to the electrolyte.

Additionally, defluorination of PVDF may occur due to the decomposition of alkaline LiOH or electrolyte from residual Li compounds on the surface of the positive electrode active material, resulting in the generation of toxic hydrofluoric acid (HF) and gelation of PVDF.

In the meantime, as unstable LiPF₆ decomposes into LiOH and HF, a series of reactions, including defluorination of PVDF, are accelerated, resulting in reduced secondary battery capacity.

Additionally, the strong Li—F bond of PVDF may hinder Li recovery during battery recycling, resulting in poor recycling efficiency, and thermal decomposition of the PVDF binder may lead to the generation of hazardous byproducts such as HF.

Therefore, there is a growing demand for the development of non-fluorinated secondary batteries the electrochemical performance of which is prevented from degradation without causing environmental and safety problems.

### DOCUMENT OF RELATED ART

### Patent Document

(Patent Document 1) Korean Patent Application Publication No. 10-2024-0066611

### SUMMARY

Hence, the present disclosure aims to provide a non-fluorinated secondary battery the electrochemical performance of which is prevented from degradation even when not using fluorine-containing compounds.

Additionally, the present disclosure aims to provide a sustainable non-fluorinated secondary battery that does not cause environmental and safety problems due to not using fluorine-containing compounds.

However, the problems to be solved by the present application are not limited to the aforementioned description, and other problems not mentioned can be clearly understood by those skilled in the art from the following description.

In one aspect of the present application, a non-fluorinated secondary battery including: a positive electrode capable of storing and releasing metal ions;
a negative electrode capable of storing and releasing metal ions;
a non-aqueous electrolyte solution including a non-aqueous solution and an electrolyte dissolved in the non-aqueous solution; and
a separator,
wherein the positive electrode, the negative electrode, the non-aqueous electrolyte solution, and the separator are free of fluorine atoms,
is provided.

In another aspect of the present application, a non-fluorinated polyamide polymer including a diamine monomer unit including a sulfone group, a diamine monomer unit including a carboxylic acid group, and a monomer unit including at least one aromatic ring,
wherein the non-fluorinated polyamide polymer is a positive electrode binder, a negative electrode binder, a separator binder, or a bare area coating binder,
is provided.

A non-fluorinated secondary battery of the present disclosure can exhibit excellent electrochemical properties even when not using fluorine-containing compounds.

Additionally, the non-fluorinated secondary battery of the present disclosure does not use fluorine-containing compounds and thus may not cause environmental and safety problems.

### DESCRIPTION OF THE PREFERRED EMBODIMENTS

Hereinafter, the action and effect of the present disclosure will be described in more detail through specific embodiments of the present disclosure. However, these embodiments are provided only for illustrative purposes of the present disclosure, and the scope of the present disclosure is not limited thereby.

Prior to discussing the details, it should be noted that all terms or words used herein and used in the appended claims are not construed as being limited to general and dictionary meanings but will be interpreted based on the meanings and concepts corresponding to the technical ideas of the present disclosure, following the principle that any inventor is allowed to define the concepts of terms as appropriate to describe the disclosure thereof in the best mode.

Therefore, the embodiments described herein are configured merely as one of the most preferable examples of the present disclosure and do not exhaustively represent the technical idea of the present disclosure. Accordingly, it should be appreciated that there may be various equivalents and modifications that can replace these embodiments as of the filing date of the present application.

As used herein, the singular forms are intended to include the plural forms, unless the context clearly indicates otherwise. It will be further understood that the terms “comprise,” “include,” “have,” and the like when used herein, are intended to specify the presence of stated features, integers, steps, constituent elements, or combinations thereof but do not preclude the possibility of the presence or addition of one or more other features, integers, steps, constituent elements, or combinations thereof.

As used herein, the expression “a to b” to represent a numerical range is defined as ≥a and ≤b.

A non-fluorinated secondary battery, according to one aspect of the present application, includes: a positive electrode capable of storing and releasing metal ions; a negative electrode capable of storing and releasing metal ions; a non-aqueous electrolyte solution including a non-aqueous solution and an electrolyte dissolved in the non-aqueous solution; and a separator, wherein the positive electrode, the negative electrode, the non-aqueous electrolyte solution, and the separator may be free of fluorine atoms.

Specifically, when the non-fluorinated secondary battery is subjected to measurement by X-ray photoelectron spectroscopy (XPS) or scanning electron microscopy/energy-dispersive X-ray spectrometry (SEM-EDS), fluorine atoms may not be detected.

In other words, the positive electrode, the negative electrode, the non-aqueous electrolyte solution, and the separator of the non-fluorinated secondary battery are free of fluorine atom-containing compounds, so fluorine atoms may not be detected when subjected to XPS or SEM-EDS measurement.

Additionally, any parts or materials that are included in the non-fluorinated secondary battery, as well as the positive electrode, the negative electrode, the non-aqueous electrolyte solution, and the separator of the non-fluorinated secondary battery, may be free of fluorine atoms and, when subjected to XPS or SEM-EDS measurement, fluorine atoms may not be detected.

In the meantime, the non-fluorinated secondary battery may not generate HF gas during operation.

In other words, the non-fluorinated secondary battery is free of fluorine atom-containing compounds, such as poly(vinylidene fluoride) (PVDF) or LiPF₆. For this reason, the formation of C═C double bonds and the generation of HF gas under the basic conditions by PVDF may be inhibited, and the generation of HF gas by decomposition reactions of LiPF₆ within the battery may be inhibited.

By inhibiting the generation of HF gas, problems that HF gas reacts with a cathode-electrolyte interphase (CEI) or solid-electrolyte interphase (SEI) layer stably formed on the surfaces of positive and negative electrode active materials, leading to the elution of transition metals and degradation of battery performance, may be solved.

Additionally, when the non-fluorinated secondary battery is a full cell, the non-fluorinated secondary battery may have an initial charge capacity of 222 mAh/g or higher, an initial discharge capacity of 186 mAh/g or higher, and an initial efficiency of 83% or higher.

For example, the initial charge capacity may be 222 mAh/g or higher and 230 mAh/g or lower, the initial discharge capacity may be 186 mAh/g or higher and 200 mAh/g or lower, and the initial efficiency may be 83% or higher and 90% or lower.

Furthermore, when the non-fluorinated secondary battery is a full cell, the non-fluorinated secondary battery may have a capacity retention rate of 89.5% or higher when performing 100 cycles of charge and discharge at room temperature (25° C.) and a capacity retention rate of 90% or higher when performing 100 cycles of charge and discharge at a high temperature (45° C.).

For example, the capacity retention rate may be 89.5% or higher and 95% or lower when performing 100 cycles of charge and discharge at room temperature (25° C.), and the capacity retention rate may be 90% or higher and 95% or lower when performing 100 cycles of charge and discharge at a high temperature (45° C.).

In one embodiment, the positive electrode may include a non-fluorinated polyamide polymer or a copolymer thereof, a non-fluorinated polyurethane polymer or a copolymer thereof, a non-fluorinated epoxy polymer or a copolymer thereof, a non-fluorinated polyimide (PI) polymer or a copolymer thereof, a non-fluorinated polyamide-imide polymer or a copolymer thereof, a non-fluorinated polyether-imide polymer or a copolymer thereof, a polyacrylate polymer or a copolymer thereof, or a combination thereof.

In one embodiment, the non-fluorinated polyamide polymer may include a sulfone-containing diamine monomer unit, a carboxylic acid-containing diamine monomer unit, and a monomer unit containing at least one aromatic ring.

The backbone of the non-fluorinated polyamide polymer may be free of an aliphatic ring structure or an aliphatic chain structure (but the aliphatic ring structure or the aliphatic chain structure may be contained as an end group other than in the backbone).

When the aliphatic ring structure or the aliphatic chain structure is contained in the backbone of the non-fluorinated polyamide polymer, problems with precipitation and the like occur due to the reduced electrode expansion suppression effect and solubility compared to the non-fluorinated polyamide polymer including the monomer unit containing at least one aromatic ring. Additionally, the electrical resistance of the battery may be increased, making the use of the non-fluorinated polyamide polymer as a binder challenging.

An electrode binder including the non-fluorinated polyamide polymer may have excellent stability to the electrolyte solution because swelling caused by the electrolyte solution occurs less than that in the case of electrode binders including existing PVDF-based polymers. Accordingly, the volume expansion of cells may occur less, resulting in improved battery stability and life.

The non-fluorinated polyamide polymer is free of fluorine atoms, and hydrogen fluoride may not be generated in the charging and discharging processes of the battery using this binder.

In contrast, currently available PVDF-based binders contain fluorine atoms, so there have been problems with the generation of hydrogen fluoride in the charging and discharging processes of batteries.

In the meantime, the sulfone-containing monomer unit may contain an aromatic ring in conjunction. The sulfone and/or the aromatic ring of the sulfone-containing monomer unit may be used to form a part of the backbone of the non-fluorinated polyamide polymer. In other words, this sulfone may be contained in the backbone of the non-fluorinated polyamide polymer.

The carboxylic acid-containing diamine monomer unit may contain one or more carboxylic acids, and this carboxylic acid may be a substituent of the aromatic ring.

Using an appropriate content of the carboxylic acid-containing diamine monomer unit may improve the binding strength of the non-fluorinated polyamide polymer while improving battery performance.

At least one aromatic ring above may be used to form a part of the backbone of the non-fluorinated polyamide polymer. In other words, this aromatic ring may be contained in the backbone of the non-fluorinated polyamide polymer.

The monomer unit containing at least one aromatic ring must be capable of generating the non-fluorinated polyamide polymer through polymerization with the diamine monomer and may contain a substituent for this purpose.

In one embodiment, a monomer that is polymerized to form the sulfone-containing monomer unit may be bis(4-aminophenyl)sulfone, bis(3-aminophenyl)sulfone, 3,3′-diaminodiphenyl sulfone, 3,4′-diaminodiphenyl sulfone, 4,4′-diaminodiphenyl sulfone, 1,3-bis(3-aminophenyl sulfone)benzene, 1,3-bis(4-aminophenyl sulfone)benzene, 1,4-bis(4-aminophenyl sulfone)benzene, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, or a combination thereof.

In particular, using bis(4-aminophenyl)sulfone could significantly improve the binding properties of the non-fluorinated polyamide polymer. Additionally, using bis(4-aminophenyl)sulfone may significantly help improve the properties of the battery using the positive electrode to which bis(4-aminophenyl)sulfone is applied (for example, properties such as the initial efficiency of the battery).

In one embodiment, a monomer that is polymerized to form the carboxylic acid-containing diamine monomer unit may be 3,5-diaminobenzoic acid (DABA).

The carboxylic acid of DABA may help improve the binding strength with an aluminum current collector.

In one embodiment, a monomer that is polymerized to form the monomer unit containing at least one aromatic ring may be a terephthaloyl chloride monomer, an isophthaloyl chloride monomer, a phthalic acid monomer, an isophthalic acid monomer, a terephthalic acid monomer, or a combination thereof.

In one embodiment, a molar ratio of terephthaloyl chloride to isophthaloyl chloride (mol % of terephthaloyl chloride:mol % of isophthaloyl chloride) used in the polymerization of the non-fluorinated polyamide polymer may be in the range of 1:9 to 9:1.

For example, the molar ratio of terephthaloyl chloride to isophthaloyl chloride may be in the range of 8:2 to 2:8 or 3:7 to 7:3.

In other words, terephthaloyl chloride and isophthaloyl chloride may be used in conjunction for the polymerization of the non-fluorinated polyamide polymer of the present application.

In one embodiment, a molar ratio of the sulfone-containing diamine monomer to the carboxylic acid-containing diamine monomer (mol % of the sulfone-containing diamine monomer:mol % of the carboxylic acid-containing diamine monomer unit) used in the polymerization of the non-fluorinated polyamide polymer may be in the range of 9.9:0.1 to 6:4.

For example, the molar ratio of the sulfone-containing diamine monomer to the carboxylic acid-containing diamine monomer may be in the range of 9.5:0.5 to 6:4, 9.5:0.5 to 7:3, 9.5:0.5 to 8:2, 9.0:1.0 to 6:4, 9.0:1.0 to 7:3, or 9.0:1.0 to 8:2.

When the content of the carboxylic acid-containing diamine monomer is higher than that in the present application, the carboxylic acid-containing diamine monomer has a smaller molecular weight than the sulfone-containing diamine monomer, resulting in poor binding strength due to limitations in the increase of the molecular weight. Additionally, secondary battery performance may be degraded.

In the meantime, when the content of the carboxylic acid-containing diamine monomer is lower than that in the present application, the binding strength may become poor, and secondary battery performance may be degraded.

In one embodiment, the non-fluorinated polyamide polymer may include a monomer repeating unit represented by Formula 1 below.

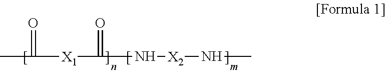

In Formula 1,
X₁ may include at least one aromatic ring substituted with a halogen element, hydrogen, a hydroxyl group, a carboxyl group, a straight-chain or branched-chain hydrocarbon group having 1 to 4 carbon atoms, or a combination thereof,
X₂ may include: two aromatic rings that are linked by —SO₂— and are substituted with a halogen element, hydrogen, a hydroxyl group, a carboxyl group, a straight-chain or branched-chain hydrocarbon group having 1 to 4 carbon atoms, the hydrocarbon group being substituted or unsubstituted with a halogen element, or a combination thereof; and
an aromatic ring substituted with at least one carboxyl group; and

$$n + m = 1 .$$

In Formula 1, n and m represent mole fractions.

The halogen element in Formula 1 may not include fluorine.

In Formula 1, the monomer unit corresponding to X₁ may correspond to the monomer unit containing at least one aromatic ring.

For example, a monomer that is polymerized to form the monomer unit corresponding to X₁ in Formula 1 may be a terephthaloyl chloride monomer, an isophthaloyl chloride monomer, a phthalic acid monomer, an isophthalic acid monomer, a terephthalic acid monomer, or a combination thereof.

Additionally, a monomer that is polymerized to form the monomer unit corresponding to X₂ in Formula 1 may be a combination of the diamine monomer containing both a sulfone and at least one aromatic ring and the carboxylic acid-containing diamine monomer.

For example, the diamine monomer that contains both a sulfone and at least one aromatic ring and is polymerized to form the monomer unit corresponding to X₂ in Formula 1 may be bis(4-aminophenyl)sulfone, bis(3-aminophenyl)sulfone, 3,3′-diaminodiphenyl sulfone, 3,4′-diaminodiphenyl sulfone, 4,4′-diaminodiphenyl sulfone, 1,3-bis(3-aminophenyl sulfone)benzene, 1,3-bis(4-aminophenyl sulfone)benzene, 1,4-bis(4-aminophenyl sulfone)benzene, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, or a combination thereof.

Additionally, the carboxylic acid-containing diamine monomer that is polymerized to form the monomer unit corresponding to X₂ in Formula 1 may be DABA.

In one embodiment, the non-fluorinated polyamide polymer may have a weight average molecular weight of 100,000 or greater and 1,000,000 or smaller.

Within the range of the weight average molecular weight of the non-fluorinated polyamide polymer of the present application, the greater the weight average molecular weight, the stronger the binding strength of the non-fluorinated polyamide polymer.

When the weight average molecular weight of the non-fluorinated polyamide polymer is smaller than 100,000, the stability of the electrode binder, including the non-fluorinated polyamide polymer, to the electrolyte solution may become poor. Additionally, the stability of an electrode slurry including the binder, including the non-fluorinated polyamide polymer, may become poor.

In the meantime, when the weight average molecular weight of the non-fluorinated polyamide polymer exceeds 1,000,000, the viscosity of the slurry may become high during preparation, making slurry coating challenging.

In one embodiment, the non-fluorinated polyamide polymer may be a positive electrode binder, a negative electrode biner, a separator binder or a bare area coating binder.

In one embodiment, the non-fluorinated secondary battery may include the positive electrode in which a positive electrode active material layer is formed by applying a positive electrode slurry including a binder solution including the positive electrode binder and a positive electrode active material.

As the positive electrode active material for forming the electrode used in the present application, a non-fluorinated positive electrode active material free of all fluorine atoms available in the related art may be used. Specific examples of such a positive electrode active material may include lithium metal; a lithium cobalt-based oxide, such as LiCoO₂; a lithium manganese-based oxide, such as Li₁₊ₓMn₂₋ₓO₄ (where x is in the range of 0 to 0.33), LiMnO₃, LiMn₂O₃, and LiMnO₂; a lithium copper oxide, such as Li₂CuO₂; a vanadium oxide, such as LiV₃O₈, V₂O₅, and Cu₂V₂O₇; a lithium nickel-based oxide represented by LiNi₁₋ₓMₓO₂ (where M is Co, Mn, Al, Cu, Fe, Mg, B, or Ga, and x is in the range of 0.01 to 0.3); a lithium manganese composite oxide represented by LiMn₂₋ₓMₓO₂ (where M is Co, Ni, Fe, Cr, Zn, or Ta, and x is in the range of 0.01 to 0.1) or Li₂Mn₃MO₈ (where M is Fe, Co, Ni, Cu, or Zn); a lithium-nickel-manganese-cobalt-based oxide represented by Li(NiₐCo_{b}Mn_{c})O₂ (where 0<a<1, 0<b<1, 0<c<1, and a +b+c=1); sulfur or a disulfide compound; a phosphate, such as LiFePO₄, LiMnPO₄, LiCoPO₄, and LiNiPO₄; and Fe₂(MoO₄)₃, but are not limited thereto.

In this case, the positive electrode active material layer may further include non-fluorinated dispersants, conductive additives, fillers, and other additives, which are free of fluorine atoms, in addition to the positive electrode active material.

The positive electrode active material may be included in an amount in the range of 90 to 99 wt % based on the solid content. When the content of the active material is low, the battery may not achieve high capacity. When the content of the active material is excessively high, the contents of the binder, the conductive additive, and the like may become relatively low, which may reduce the adhesive strength, conductivity, and the like of the electrode.

The conductive additive is not particularly limited and may be appropriately selected depending on the types of battery and capacitor. For example, in the case of lithium-ion secondary batteries, carbon such as graphite and activated carbon may be used as the conductive additive. Additionally, in the case of nickel-hydrogen secondary batteries, cobalt oxide may be used, and nickel powder, cobalt oxide, titanium oxide, carbon, and the like may be used for the negative electrode.

Examples of the carbon may include acetylene black, furnace black, graphite, carbon fibers, fullerenes, and carbon nanotubes.

The amount of the conductive additive used, based on 100 parts by weight of the electrode active material, is typically in the range of 1 to 20 parts by weight and preferably in the range of 2 to 10 parts by weight.

With the decreasing content of the conductive additive and the increasing content of the positive electrode active material, the energy density of the secondary battery may be improved. Thus, it is important to achieve high efficiency even when using the same amount of the conductive additive.

When the conductive additive used in the electrode slurry for the secondary battery is more finely and evenly dispersed, the conductive efficiency becomes higher, resulting in lower resistance within the battery, better output characteristics, and better life characteristics. When the conductive additive used is largely and unevenly dispersed, the binding properties and conductivity become lower even when using the same amount, so the life characteristics and output characteristics of the battery are adversely affected. Additionally, when the viscosity of the resulting dispersion is low, the solid content of the slurry may be increased to improve the electrode production speed.

As the positive electrode binder of the secondary battery, any one of poly(methacrylic acid), poly(methacrylamide), carboxymethyl cellulose (CMC), poly(vinyl acetate), polyvinyl alcohol, polyethylene oxide, polyvinylpyrrolidone, alkylated polyethylene oxide, polyvinyl ether, poly(methyl methacrylate), poly(ethyl acrylate), polyvinyl chloride, polyacrylonitrile (PAN), polyvinylpyridine, styrene-butadiene rubber (SBR), acrylonitrile-butadiene rubber, and copolymers thereof, which are non-fluorinated polymers free of fluorine atoms, may be used, or two or more types of the foregoing may be selected and used together, in addition to the positive electrode binder including the non-fluorinated polyamide polymer of the present application.

The content of the binder in a positive electrode slurry composition is preferably 0.3 wt % or more and 10 wt % or less based on the solid content, which is more preferably 0.7 wt % or more and 8 wt % or less. When the content of the binder is less than 0.3 wt %, achieving sufficient binding strength within a current collector and an electrode composition may be highly unlikely. When the content of the binder exceeds 10 wt %, the proportion of the binder within the electrode slurry composition increases, resulting in reduced battery capacity.

In one embodiment, the positive electrode of the non-fluorinated secondary battery may include a current collector and the positive electrode active material layer formed on the current collector, the positive electrode active material layer including the positive electrode binder of the present application.

The positive electrode may be manufactured through the following steps: (a) preparing a composition for forming the positive electrode active material layer, the composition including the positive electrode active material and the binder of the present application; and (b) applying the composition for forming the positive electrode active material layer on the positive electrode current collector, followed by drying.

The composition for forming the positive electrode active material layer may be mixed by common stirring methods, for example, using common mixers such as a high-speed shear mixer, a homomixer, and the like.

Step (b) is to manufacture the positive electrode for a lithium secondary battery by applying the composition for forming the positive electrode active material layer, prepared in Step (a), on the positive electrode current collector, followed by drying.

In this case, there are no limitations in methods of applying the slurry-form composition for forming the positive electrode active material layer. For example, methods such as doctor blade coating, dip coating, gravure coating, slit die coating, spin coating, comma coating, bar coating, reverse roll coating, screen coating, and cap coating may be performed to manufacture the positive electrode.

The resulting product obtained through the application may then be dried to finally manufacture the positive electrode for the secondary battery (especially a lithium secondary battery) in which the positive electrode active material layer is formed.

As the current collector, any of those that are conductive and do not chemically react with the slurry for forming the electrode may be used. Representative examples thereof include an aluminum foil, a copper foil, and the like. Additionally, a current collector having a thickness in the range of 3 to 50 μm may be selected for use.

In one embodiment, the negative electrode may include a non-fluorinated polymer free of fluorine atoms. In particular, the non-fluorinated polymer of the negative electrode may be an aqueous polymer.

In one embodiment, the non-fluorinated polymer of the negative electrode may include SBR or a copolymer thereof, CMC or a copolymer thereof, polyacrylic acid (PAA) or a copolymer thereof, a PAA metal salt (Metal-PAA) or a copolymer thereof, poly(vinyl acetate) or a copolymer thereof, poly(methacrylic acid) or a copolymer thereof, polymethyl methacrylate or a copolymer thereof, polymethacrylamide or a copolymer thereof, PAN or a copolymer thereof, polymethacrylonitrile or a copolymer thereof, PI or a copolymer thereof, chitosan or a copolymer thereof, starch or a copolymer thereof, polyvinylpyrrolidone or a copolymer thereof, polyethylene or a copolymer thereof, polypropylene or a copolymer thereof, an ethylene-propylene-diene polymer (EPDM) or a copolymer thereof, a sulfonated-EPDM or a copolymer thereof, hydroxypropyl cellulose or a copolymer thereof, regenerated cellulose or a copolymer thereof, or a combination thereof.

For example, the non-fluorinated polymer of the negative electrode may include SBR and CMC, and a weight ratio of SBR to CMC (weight of SBR:weight of CMC) may be in the range of 0.5 to 5:1.

When the weight ratio of SBR to CMC exceeds the range in the present disclosure, it may be challenging to realize battery capacity. When the weight ratio of SBR to CMC falls below the range in the present application, the binding strength of the electrode may become poor.

In one embodiment, the non-fluorinated polymer of the negative electrode may be a negative electrode binder.

In one embodiment, the non-fluorinated secondary battery may include the negative electrode in which a negative electrode active material layer is formed by applying a negative electrode slurry including a binder solution including the negative electrode binder and a negative electrode active material.

The negative electrode active material may be one selected from the group consisting of non-fluorinated carbon-based materials, silicon, alkali metals, alkaline earth metals, elements of group 13, elements of group 14, transition metals, and rare-earth elements, which are free of fluorine atoms, or a compound including one or more selected from the foregoing group. Preferably, the negative electrode active material is silicon or a silicon-containing compound.

Examples of the carbon-based materials may include synthetic graphite, natural graphite, hard carbon, soft carbon, and the like, but are not limited thereto. The silicon-containing negative electrode active material is not particularly limited in type as long as it is silicon or a silicon-containing compound. However, the silicon-containing negative electrode active material is preferably one or more selected from the group consisting of Si, SiOₓ (where 0<x<2), Si—Y alloys (where Y is an alkali metal, an alkaline earth metal, an element of group 13, an element of group 14, a transition metal, a rare-earth element, or a combination thereof, but not Si), and Si—C composites.

For example, the carbon-based material may include synthetic graphite and natural graphite, and a weight ratio of synthetic graphite to natural graphite (weight of synthetic graphite:weight of natural graphite) may be in the range of 1 to 9.5:1.

Additionally, when mixed with other negative electrode active materials, which differ from the silicon-containing negative electrode active material, for use as the negative electrode active material, the silicon-containing negative electrode active material may be included in an amount of 8 wt % or more of the total weight of the negative electrode active material.

The negative electrode active material layer, based on the total weight thereof, may include 50 to 98 wt % of the negative electrode active material.

When less than 50 wt % of the negative electrode active material is included, the energy density may decrease, making it impossible to manufacture a battery with high energy density. When more than 98 wt % of the negative electrode active material is included, the contents of a conductive additive and the binder decrease, so the electrical conductivity may decrease, and the adhesive strength between the electrode active material layer and a current collector may decrease.

In the meantime, the negative electrode slurry, with respect to the total weight thereof, may include 1 to 35 wt % of the negative electrode binder of the present application. With less than 1 wt % of the negative electrode binder, the physical properties of the negative electrode deteriorate, so the negative electrode active material and the conductive additive may be delaminated. With more than 35 wt % of the negative electrode binder, the proportions of the negative electrode active material and the conductive additive may relatively decrease, resulting in reduced battery capacity. Additionally, the electrical conductivity of the negative electrode may become poor.

The negative electrode may include a current collector and the negative electrode active material layer formed on the current collector, the negative electrode active material layer including the negative electrode binder of the present application.

The negative electrode active material layer may further include a non-fluorinated conductive additive free of fluorine atoms. The conductive additive is used to further improve the conductivity of the negative electrode active material. Such a conductive additive is not particularly limited as long as it is free of fluorine atoms and does not cause chemical changes in batteries in the related art while being conductive. Examples of the conductive additive used may include: graphite, such as natural graphite and synthetic graphite; carbon black, such as acetylene black, Ketjen black, channel black, furnace black, lamp black, and thermal black; conductive fibers, such as carbon fibers and metal fibers; metal powders, such as aluminum, and nickel powder; conductive whiskers, such as zinc oxide and potassium titanate; conductive metal oxides, such as titanium oxide; polyphenylene derivatives; and the like.

The negative electrode active material layer, with respect to the total weight thereof, may include 0.05 to 30 wt %, preferably 15 to 25 wt %, of the conductive additive. When less than 0.05 wt % of the conductive additive is included, the electrical conductivity of the negative electrode is reduced. When more than 30 wt % of the conductive additive is included, the proportions of the silicon-based negative electrode active material and the binder may relatively decrease, resulting in reduced battery capacity. Additionally, the content of the negative electrode active material decreases because the binder content needs to increase to keep the negative electrode active material layer, making it impossible to manufacture a battery with high energy density

Because the negative electrode active material layer includes the negative electrode binder, the negative electrode may suppress the volume expansion of the negative electrode active material from occurring when the secondary battery is charged and discharged and improve the capacity retention rate per cycle.

The negative electrode may be manufactured through the following steps: (a) preparing a composition for forming the negative electrode active material layer, the composition including the negative electrode active material and the negative electrode binder; and (b) applying the composition for forming the negative electrode active material layer on the negative electrode current collector, followed by drying.

The composition for forming the negative electrode active material layer is prepared in a negative electrode slurry form. A solvent used to prepare the slurry form should be easily dried. In addition, any of those capable of well-dissolving the negative electrode binder but enabling the negative electrode active material to remain dispersed without being dissolved is the most preferable.

As the solvent according to the present application, water or a non-fluorinated organic solvent free of fluorine atoms is usable. Additionally, an organic solvent including one or more selected from the group consisting of methylpyrrolidone, dimethylformamide, isopropyl alcohol, acetonitrile, methanol, ethanol, and tetrahydrofuran is applicable as the organic solvent.

The composition for forming the negative electrode active material layer may be mixed by common stirring methods using common mixers, for example, a latex mixer, a high-speed shear mixer, a homomixer, and the like.

Step (b) is to manufacture the negative electrode for a lithium secondary battery by applying the composition for forming the negative electrode active material layer, prepared in Step (a), on the negative electrode current collector, followed by drying.

The negative electrode current collector may be selected from the group consisting of non-fluorinated copper, stainless steel, titanium, silver, palladium, nickel, alloys thereof, and combinations thereof, which are free of fluorine atoms. The surface of the stainless steel may be treated with carbon, nickel, titanium, or silver, and an aluminum-cadmium alloy may be used as the above alloy. Additionally, calcined carbon, a non-conductive polymer the surface of which is treated with a conductive additive, a conductive polymer, or the like, which are free of fluorine atoms, may be used.

The composition for forming the negative electrode active material layer, prepared in Step (a), is applied onto the negative electrode current collector. The current collector may be coated to have a suitable thickness depending on the desired thickness to be formed, and the thickness is preferably selected appropriately within the range of 10 to 300 μm.

In this case, there are no limitations in methods of applying the slurry-form composition for forming the negative electrode active material layer. For example, methods such as doctor blade coating, dip coating, gravure coating, slit die coating, spin coating, comma coating, bar coating, reverse roll coating, screen coating, and cap coating may be performed to manufacture the negative electrode.

The resulting product obtained through the application may then be dried to finally manufacture the negative electrode for the secondary battery (especially a lithium secondary battery) in which the negative electrode active material layer is formed.

In one embodiment, the electrolyte of the non-aqueous electrolyte solution may contain a non-fluorinated lithium salt.

The non-fluorinated lithium salt may be lithium perchlorate (LiClO₄), LiCl, LiBr, LiI, LiClO₄, LiB₁₀Cl₁₀, LiAlCl₄, LiSCN, LiC₄BO₈, LiCH₃SO₃, lithium chloroborane, lithium lower aliphatic carboxylate, lithium 4-phenyl borate imide, or a combination thereof.

For example, the non-fluorinated lithium salt may be lithium perchlorate (LiClO₄).

In one embodiment, the non-aqueous solution of the non-aqueous electrolyte solution may include vinylene carbonate, propylene sulfone, lithium bisoxalatoborate (LiBOB), N-methyl-2-pyrrolidone, propylene carbonate, ethylene carbonate, butylene carbonate, dimethyl carbonate, diethyl carbonate, ethyl methyl carbonate, gamma-butyrolactone, 1,2-dimethoxy ethane, 1,2-diethoxy ethane, tetrahydroxy franc, 2-methyl tetrahydrofuran, dimethyl sulfoxide, 1,3-dioxolane, 4-methyl-1,3-dioxene, diethyl ether, formamide, dimethylformamide, dioxolane, acetonitrile, nitromethane, methyl formate, methyl acetate, phosphoric acid triester, trimethoxy methane, dioxolane derivatives, sulfolane, methylsulfolane, 1,3-dimethyl-2-imidazolidinone, propylene carbonate derivatives, tetrahydrofuran derivatives, ether, methyl propionate, ethyl propionate, or a combination thereof, which are a non-fluorinated solution free of fluorine atoms.

For example, the non-aqueous solution may include ethylene carbonate, ethyl methyl carbonate, and dimethyl carbonate. In this case, a volume ratio or weight ratio of ethylene carbonate, ethyl methyl carbonate, and dimethyl carbonate may be in the range of 1:0 to 2:0 to 2.

In particular, the volume ratio or weight ratio of ethylene carbonate, ethyl methyl carbonate, and dimethyl carbonate may be 1:1:1.

When the content ratio of ethylene carbonate exceeds the range in the present application, the mobility of the lithium salt may become poor due to high viscosity.

In the meantime, when the content ratios of ethyl methyl carbonate and dimethyl carbonate exceed the range in the present application, decomposition of the lithium salt may be challenging.

Additionally, the non-aqueous solution may include vinylene carbonate, propylene sulfone, LiBOB, or a combination thereof.

In this case, vinylene carbonate and propylene sulfone may be each independently included in an amount in the range of 1 to 5 wt % of the total weight of the non-fluorinated electrolyte solution.

When the contents of vinylene carbonate and propylene sulfone fall below the range in the present application, the initial charge capacity, the initial discharge capacity, and the initial efficiency of the battery may become poor. When the contents of vinylene carbonate and propylene sulfone exceed the range in the present application, the cycle and capacity characteristics of the battery may deteriorate due to side reactions.

Additionally, LiBOB may be included in an amount in the range of 0.01 to 1 wt % of the total weight of the non-fluorinated electrolyte solution.

When the LiBOB content does not fall within the range in the present application, the cycle retention characteristics and high-temperature stability characteristics of the battery may deteriorate.

In the meantime, the electrolyte may include non-fluorinated organic solid electrolytes, inorganic solid electrolytes, or a combination thereof, which are free of fluorine atoms.

Examples of the organic solid electrolytes used may include polymers containing secondary dissociation groups, polyethylene derivatives, polyethylene oxide derivatives, polypropylene oxide derivatives, phosphoric acid ester polymers, polyagitation lysine, polyester sulfide, polyvinyl alcohol, and the like.

Examples of the inorganic solid electrolytes used may include nitrides, halides, sulfates, and the like of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

Additionally, the non-aqueous electrolyte solution may further include other non-fluorinated additives free of fluorine atoms for the purposes of improving the charge and discharge characteristics, flame retardancy, and the like. Examples of the additives may include pyridine, triethyl phosphite, triethanolamine, cyclic ether, ethylene diamine, n-glyme, hexaphosphoric acid triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxyethanol, aluminum trichloride, propene sultone (PRS), and the like.

In one embodiment, the separator may be a porous substrate made of any one or a mixture of two or more selected from the group consisting of non-fluorinated polyethylene, polypropylene, polybutylene, polypentene, polybutylene terephthalate, polyester, polyacetal, polyamide, polycarbonate, PI, polyether ether ketone, polyethersulfone, polyphenylene oxide, polyphenylene sulfide, and polyethylene naphthalate, which are free of fluorine atoms.

The separator provides a passage through which only lithium ions can move and must be an insulator so that the negative and positive electrodes are kept apart from each other.

To this end, the separator must have good wettability with the electrolyte. Additionally, a coated separator that is coated with ceramic or the like and has enhanced thermal resistance and mechanical strength may be used to prevent battery short circuits, and the coating may be applied in either a single-layer or multilayer structure.

The separator may be a porous substrate.

The lithium secondary battery, according to the present disclosure, may be subjected to folding and lamination stacking processes of the separator and the electrodes, in addition to a typical winding process. Additionally, a case of the battery may be cylindrical, prismatic, pouch-type, coin-type, or the like.

Hereinafter, the present application will be described in more detail using the following examples. However, the present application is not limited thereto.

### Preparation Example 1. Preparation of Non-Fluorinated Polyamide Polymer Binder

To a 500 ml four-necked flask under a nitrogen atmosphere, N-methyl-2-pyrrolidone (NMP), bis(4-aminophenyl)sulfone (p-APS), serving as a monomer to form a sulfone-containing monomer unit, and 3,5-diaminobenzoic acid (DABA), serving as a carboxylic acid-containing diamine monomer, were added, followed by stirring.

The molar ratio of the p-APS to the DABA was 9:1.

Thereafter, the temperature inside the reactor was cooled to 5° C. or lower, and isophthaloyl chloride (IPC), serving as an aromatic ring-containing monomer unit, was added and reacted.

Then, terephthaloyl chloride (TPC), serving as a monomer to form the aromatic ring-containing monomer unit, was added to the reactor and stirred for a sufficient time.

The molar ratio of the IPC to the TPC was 3:7.

An olefin-based neutralizing agent was added to the solution the viscosity of which increased by a certain degree and stirred to remove HCl generated during the synthesis process.

Finally, a non-fluorinated polyamide polymer binder solution, in which the solid content concentration was 15 wt %, was prepared.

### Preparation Example 2. Preparation of Non-Fluorinated Positive Electrode Slurry and Manufacture of Positive Electrode

A positive electrode active material slurry composition, in which the solid content was 70 wt %, was prepared by mixing 97.5 wt % of NCM811, serving as an electrode active material, 2 wt % of the non-fluorinated polyamide polymer binder prepared by Preparation Example 1, 0.5 wt % of a carbon nanotube (CNT) dispersion, and the remainder of NMP.

In the meantime, the positive electrode active material slurry composition may include 96 wt % or more and 98 wt % or less of the electrode active material, 1 wt % or more and 3 wt % or less of the non-fluorinated polyamide polymer binder, and 0.5 wt % or more and 1 wt % or less of the CNT dispersion. Additionally, the solid content of the positive electrode active material slurry composition may be 60 wt % or more and 75 wt % or less.

A 20 um-thick aluminum (Al) foil, serving as a positive electrode current collector, was coated with such a prepared positive electrode slurry composition using an applicator and dried in a convection oven at a temperature of 130° C. for 1 hour, followed by rolling using a roll press to manufacture a positive electrode.

### Preparation Example 3. Preparation of Non-Fluorinated Negative Electrode Slurry and Manufacture of Negative Electrode

Based on 100 parts by weight of the total slurry solid content, synthetic graphite and natural graphite, serving as electrode active materials, and SBR and CMC, serving as binders, were mixed, followed by adding distilled water, to prepare a negative electrode slurry, in which the slurry solid content was adjusted to 50% by weight.

In this case, the weight percentages of synthetic graphite, natural graphite, styrene-butadiene rubber (SBR), and carboxymethyl cellulose (CMC) were 85 wt %, 10 wt %, 3 wt %, and 2 wt %, respectively.

Such a prepared negative electrode slurry was evenly applied onto a copper current collector, followed by drying at a temperature of 110° C. The resulting compound was rolled using a roll press and thermally treated in a vacuum oven at a temperature of 110° C. for 4 or more hours to manufacture a negative electrode.

### Preparation Example 4. Preparation of Non-Fluorinated Electrolyte Solution

### Preparation Example 4-1

Ethylene carbonate (EC), ethyl methyl carbonate (EMC), and dimethyl carbonate (DMC), serving as organic solvents, were introduced into a vial at a ratio of 1:1:1 (v:v:v). Then, 1 mol/L of LiClO₄ lithium salts were added, stirred at room temperature, and dissolved.

Thereafter, 1 wt % of vinylene carbonate (VC), 1 wt % of propylene sulfone (PS), and 0.1 wt % of lithium bisoxalatoborate (LiBOB), serving as additives, were added and dissolved.

### Preparation Example 4-2

An electrolyte solution was prepared in the same manner as in Preparation Example 4-1, except for not adding LiBOB, the additive.

### Preparation Example 4-3

An electrolyte solution was prepared in the same manner as in Preparation Example 4-1, except for not adding PS and LiBOB, the additives.

### Preparation Example 5. Manufacture of Cell

### [Preparation Example 5-1] Manufacture of Half-Cell

A polyolefin separator was interposed between lithium metal and the positive electrode using the positive electrode plate manufactured by Preparation Example 2, followed by manufacturing a lithium secondary battery without distinguishing the form thereof into a 2032 coin cell or pouch type.

In this case, as an electrolyte solution, the electrolyte solution prepared by Preparation Example 4 was used.

### [Preparation Example 5-2] Manufacture of Full Cell

A polyolefin separator was interposed between the positive electrode using the positive electrode plate manufactured by Preparation Example 2 and the negative electrode manufactured by Preparation Example 3, followed by manufacturing a lithium secondary battery without distinguishing the form thereof into a 2032 coin cell or pouch type.

In this case, as an electrolyte solution, the electrolyte solution prepared by Preparation Example 4 was used.

### Examples and Comparative Examples

### Example 1

A cell was manufactured according to Preparation Example 5-1 using the electrolyte solution of Preparation Example 4-1 as an electrolyte solution.

### Example 2

A cell was manufactured according to Preparation Example 5-2 using the electrolyte solution of Preparation Example 4-1 as an electrolyte solution.

### Example 3

A cell was manufactured according to Preparation Example 5-2 using the electrolyte solution of Preparation Example 4-2 as an electrolyte solution.

### Example 4

A cell was manufactured according to Preparation Example 5-2 using the electrolyte solution of Preparation Example 4-3 as an electrolyte solution.

### Comparative Example 1

A cell was manufactured in the same manner as in Example 1, except for using a poly(vinylidene fluoride) (PVDF) binder (weight average molecular weight: 1,000,000, melting point: 150° C. to 160° C., glass transition temperature: −40° C., purchased from Solvay) instead of the non-fluorinated polyamide polymer binder of Preparation Example 1 to prepare the positive electrode slurry and manufacture the positive electrode according to Preparation Example 2.

### Comparative Example 21

A cell was manufactured in the same manner as in Example 1, except for using a fluorinated compound-containing electrolyte solution instead of the non-fluorinated electrolyte solution of Preparation Example 4.

The fluorine compound-containing electrolyte solution was a non-aqueous electrolyte solution to which 1 M LiPF₆, 1 wt % of fluoroethylene carbonate (FEC), 1 wt % of PS, and 1 wt % of LiPO₂F₂ were added.

### Comparative Example 3

A cell was manufactured in the same manner as in Example 1, except for using a PVDF binder instead of the non-fluorinated polyamide polymer binder of Preparation Example 1 to prepare the positive electrode slurry and manufacture the positive electrode according to Preparation Example 2 and for using a fluorinated compound-containing electrolyte solution instead of the non-fluorinated electrolyte solution of Preparation Example 4.

The fluorine compound-containing electrolyte solution was a non-aqueous electrolyte solution to which 1 M LiPF₆, 1 wt % of FEC, 1 wt % of PS, and 1 wt % of LiPO₂F₂ were added.

### Comparative Example 4

A cell was manufactured in the same manner as in Example 2, except for using a PVDF binder instead of the non-fluorinated polyamide polymer binder of Preparation Example 1 to prepare the positive electrode slurry and manufacture the positive electrode according to Preparation Example 2.

### Comparative Example 5

A cell was manufactured in the same manner as in Example 2, except for using a fluorinated compound-containing electrolyte solution instead of the non-fluorinated electrolyte solution of Preparation Example 4.

The fluorine compound-containing electrolyte solution was a non-aqueous electrolyte solution to which 1 M LiPF₆, 1 wt % of FEC, 1 wt % of PS, and 1 wt % of LiPO₂F₂ were added.

### Comparative Example 6

A cell was manufactured in the same manner as in Example 2, except for using a PVDF binder instead of the non-fluorinated polyamide polymer binder of Preparation Example 1 to prepare the positive electrode slurry and manufacture the positive electrode according to Preparation Example 2 and for using a fluorinated compound-containing electrolyte solution instead of the non-fluorinated electrolyte solution of Preparation Example 4.

The fluorine compound-containing electrolyte solution was a non-aqueous electrolyte solution to which 1 M LiPF₆, 1 wt % of FEC, 1 wt % of PS, and 1 wt % of LiPO₂F₂ were added.

The methods of manufacturing the positive electrodes, negative electrodes, electrolytes, and cells of Examples 1 to 4 and Comparative Examples 1 to 6 are shown in Table 1 below.

TABLE 1

| | | Negative | | Manufacture of |
|---|---|---|---|---|
| | Positive electrode | electrode | Electrolyte | cell |
| Example 1 | Preparation | Preparation | Preparation | Preparation |
| | Example 2 | Example 3 | Example 4-1 | Example 5-1 |
| Example 2 | Preparation | Preparation | Preparation | Preparation |
| | Example 2 | Example 3 | Example 4-1 | Example 5-2 |
| Example 3 | Preparation | Preparation | Preparation | Preparation |
| | Example 2 | Example 3 | Example 4-2 | Example 5-2 |
| Example 4 | Preparation | Preparation | Preparation | Preparation |
| | Example 2 | Example 3 | Example 4-3 | Example 5-2 |
| Comparative | Using PVDF | Preparation | Preparation | Preparation |
| Example 1 | binder | Example 3 | Example 4-1 | Example 5-1 |
| Comparative | Preparation | Preparation | LiPF₆, FEC, PS, | Preparation |
| Example 2 | Example 2 | Example 3 | LiPO₂F₂ | Example 5-1 |
| Comparative | Using PVDF | Preparation | LiPF₆, FEC, PS, | Preparation |
| Example 3 | binder | Example 3 | LiPO₂F₂ | Example 5-1 |
| Comparative | Using PVDF | Preparation | Preparation | Preparation |
| Example 4 | binder | Example 3 | Example 4-1 | Example 5-2 |
| Comparative | Preparation | Preparation | LiPF₆, FEC, PS, | Preparation |
| Example 5 | Example 2 | Example 3 | LiPO₂F₂ | Example 5-2 |
| Comparative | Using PVDF | Preparation | LiPF₆, FEC, PS, | Preparation |
| Example 6 | binder | Example 3 | LiPO₂F₂ | Example 5-2 |

### Evaluation Example 1. Measurement of Presence of HF Gas

The non-fluorinated polyamide polymer binder of Preparation Example 1 and the PVDF binder were separately immersed in the fluorinated compound-containing electrolyte solution to which 1 M LiPF₆, 1 wt % of FEC, 1 wt % of PS, and 1 wt % of LiPO₂F₂ were added and then left unattended at a temperature of 45° C. for 24 hours. Then, color changes were visually observed while measuring pH changes with litmus paper.

Additionally, the non-fluorinated polyamide polymer binder of Preparation Example 1 and the PVDF binder were separately immersed in the non-fluorinated electrolyte solution of Preparation Example 4-1 and then left unattended at a temperature of 45° C. for 24 hours. Then, color changes were visually observed while measuring pH changes with litmus paper.

When immersing the PVDF binder in the fluorinated compound-containing electrolyte solution, yellow discoloration was detected, and the pH was measured to be 2.

This is because HF gas was generated through the formation of double bonds and the decomposition of LiPF₆ by PVDF.

In the meantime, when immersing the non-fluorinated polyamide polymer binder of Preparation Example 1 in the fluorinated compound-containing electrolyte solution, there was no change in color, and the pH was measured to be 6.

Additionally, in both cases where the non-fluorinated polyamide polymer binder of Preparation Example 1 and the PVDF binder were each independently immersed in the non-fluorinated electrolyte solution of Preparation Example 4-1, there was no change in color, and the pH was measured to be 6.

In other words, when using either the non-fluorinated polyamide polymer binder of Preparation Example 1 or the non-fluorinated electrolyte solution of Preparation Example 4-1, the generation of HF gas could be prevented.

### Evaluation Example 2. Measurement of Half-Cell Performance

Each cell of Example 1 and Comparative Examples 1 to 3 was charged at a 0.1 C rate up to 4.2 V and then discharged at a 0.1 C rate down to 2.8 V, charged at a 0.2 C rate up to 4.2 V and then discharged at a 0.2 C rate down to 2.8 V, and charged at a 0.5 C rate up to 4.2 V and then discharged at a 0.5 C rate down to 2.8 V, in constant current/constant voltage (CC/CV) mode (initial formation). In this case, the temperature of a chamber was 25° C. The “C” above, which is the discharge rate of each cell, refers to a value obtained by dividing the total capacity of the cell by the total discharge time.

The initial charge capacity, the initial discharge capacity, and the initial efficiency of each cell of Example 1 and Comparative Examples 1 to 3 were measured. The results thereof are shown in Table 2 below.

During the initial formation, the charge capacity when charging each cell at a 0.1 C rate up to 4.2 V and the discharge capacity when discharging each cell at a 0.1 C rate down to 2.8 V were measured as the initial charge capacity and the initial discharge capacity, respectively, and the initial efficiency was calculated using Equation 1 below.

$$Initial efficiency [ \% ] = [ Initial discharge capacity / Initial charge capacity ] * 100 \qquad 〈 Equation 1 〉$$

TABLE 2

| | Initial charge | Initial discharge | Initial efficiency |
|---|---|---|---|
| | capacity (mAh/g) | capacity (mAh/g) | (%) |
| Example 1 | 211.64 | 197.12 | 93.14 |
| Comparative | 210.87 | 196.44 | 93.16 |
| Example 1 | | | |
| Comparative | 211.34 | 196.51 | 92.98 |
| Example 2 | | | |
| Comparative | 210.34 | 195.40 | 92.89 |
| Example 3 | | | |

As shown in Table 2, the cell of Example 1 using the non-fluorinated positive electrode, the non-fluorinated polyamide polymer positive electrode binder, and the non-fluorinated electrolyte solution exhibited the best initial charge capacity characteristics and initial discharge capacity characteristics, compared to the cell of Comparative Example 1 manufactured using fluorinated PVDF, the cell of Comparative Example 2 using the fluorinated electrolyte solution, and the cell of Comparative Example 3 using PVDF and the fluorinated electrolyte solution.

Additionally, the initial efficiency characteristics of the cell of Example 1 were superior to those of the cells of Comparative Examples 2 and 3 and were at an equivalent level to those of the cell of Comparative Example 1.

In other words, it was confirmed that the non-fluorinated electrolyte solution could replace the fluorinated electrolyte solution to provide a cell with equivalent or superior characteristics, and the non-fluorinated binder could also replace the fluorinated binder to provide a cell with equivalent or superior characteristics.

In particular, it was confirmed that the non-fluorinated secondary battery could address problems with Li-ion movement and side reactions caused by fluorine functional groups in the battery compared to fluorinated secondary batteries.

### Evaluation Example 3. Measurement of Full-Cell Performance

The initial charge capacity, the initial discharge capacity, and the initial efficiency of each cell of Examples 2 to 4 and Comparative Examples 4 to 6 were measured in the same manner as in Evaluation Example 2. The results thereof are shown in Table 3 below.

TABLE 3

| | Initial charge | Initial discharge | Initial efficiency |
|---|---|---|---|
| | capacity (mAh/g) | capacity (mAh/g) | (%) |
| Example 2 | 225.26 | 197.02 | 87.46 |
| Example 3 | 224.05 | 193.98 | 86.57 |
| Example 4 | 222.44 | 186.37 | 83.78 |
| Comparative | 229.59 | 187.94 | 81.86 |
| Example 4 | | | |
| Comparative | 224.08 | 193.78 | 86.48 |
| Example 5 | | | |
| Comparative | 224.60 | 187.51 | 83.48 |
| Example 6 | | | |

As shown in Table 3, in the case of the cells of Examples 2 to 4, where the non-fluorinated electrolyte solution was free of LiBOB and/or PS, it was confirmed that the initial charge capacity, the initial discharge capacity, and the initial efficiency of the cells were slightly reduced.

In the meantime, in the case of the cell of Comparative Example 4, which differed from the cell of Example 2 only in that the fluorinated positive electrode was used instead of the non-fluorinated positive electrode, the initial charge capacity was slightly higher than that of the cell of Example 2, but the initial discharge capacity and the initial efficiency were reduced.

Additionally, in the case of the cell of Comparative Example 5, which differed from the cell of Example 2 only in that the fluorinated electrolyte solution was used instead of the non-fluorinated electrolyte solution, all the initial charge capacity, the initial discharge capacity, and the initial efficiency were reduced compared to those of the cell of Example 2.

Furthermore, also in the case of the cell of Comparative Example 6, which differed from the cell of Example 2 only in that the fluorinated positive electrode was used instead of the non-fluorinated positive electrode and the fluorinated electrolyte solution was used instead of the non-fluorinated electrolyte solution, all the initial charge capacity, the initial discharge capacity, and the initial efficiency were reduced compared to those of the cell of Example 2.

### Evaluation Example 4. Measurement of Capacity Retention Rate

Two cycles of charge and discharge were performed on each cell of Example 2 and Comparative Examples 2 to 4 in CC/CV mode under the following conditions: a temperature of 25° C., a charge and discharge current density of 0.1 C, a charge cut-off voltage of 4.2 V, and a discharge cut-off voltage of 2.8 V.

Then, the capacity retention rate was measured by performing 100 cycles of charge and discharge in CC/CV mode under the following conditions: a charge and discharge current density of 1 C, a charge cut-off voltage of 4.2 V, and a discharge cut-off voltage of 2.8 V.

In each case, by adjusting the temperature of a chamber to room temperature (25° C.) and a high temperature (45° C.), the room-temperature capacity retention rate and the high-temperature capacity retention rate were measured. The results thereof are shown in Table 4 below.

The discharge was all performed under CC/CV conditions, and the CV discharge cut-off current was set to 0.005 C.

In this case, the capacity retention rate was calculated according to Equation 2 below.

$$Capacity retention rate ( \% ) = ( discharge capacity after 100 cycles / \\ discharge capacity after 1 cycle ) * 100 \qquad [ Equation 2 ]$$

TABLE 4

| | Capacity retention rate (100 cycle) | |
|---|---|---|
| | Room temperature (25° C.) | High temperature (45° C.) |
| Example 2 | 89.90 | 91.11 |
| Comparative | 89.38 | 89.17 |
| Example 4 | | |
| Comparative | 86.28 | 88.82 |
| Example 5 | | |
| Comparative | 82.33 | 88.60 |
| Example 6 | | |

As shown in Table 4, in the case of the cell of Comparative Example 4, which differed from the cell of Example 2 only in that the fluorinated positive electrode was used instead of the non-fluorinated positive electrode, both the room-temperature and high-temperature capacity retention rates were reduced compared to those of the cell of Example 2.

Additionally, in the case of the cell of Comparative Example 5, which differed from the cell of Example 2 only in that the fluorinated electrolyte solution was used instead of the non-fluorinated electrolyte solution, both the room-temperature and high-temperature capacity retention rates were reduced compared to those of the cell of Example 2.

In the meantime, also in the case of the cell of Comparative Example 6, which differed from the cell of Example 2 only in that the fluorinated positive electrode was used instead of the non-fluorinated positive electrode and the fluorinated electrolyte solution was used instead of the non-fluorinated electrolyte solution, both the room-temperature and high-temperature capacity retention rates were reduced compared to those of the cell of Example 2.

As a result, it was confirmed that the non-fluorinated secondary battery free of fluorine atoms of the present application exhibited electrochemical performance equivalent or superior to that of fluorinated secondary batteries including fluorine atom-containing compounds.

Additionally, the non-fluorinated secondary battery of the present application was confirmed to be a sustainable secondary battery without causing environmental and safety problems occurring due to the use of fluorine atom-containing compounds.

The scope of the present disclosure is defined by the appended claims rather than the detailed description presented above. All changes or modifications derived from the meaning and scope of the claims and the concept of equivalents should be construed to fall within the scope of the present disclosure.

What is claimed is:

1. A non-fluorinated secondary battery comprising:
a positive electrode capable of storing and releasing metal ions;
a negative electrode capable of storing and releasing metal ions; a non-aqueous electrolyte solution comprising a non-aqueous solution and an electrolyte dissolved in the non-aqueous solution; and
a separator,
wherein the positive electrode, the negative electrode, the non-aqueous electrolyte solution, and the separator are free of fluorine atoms.

2. The non-fluorinated secondary battery of claim 1, wherein the positive electrode comprises a non-fluorinated polyamide polymer or a copolymer thereof, a non-fluorinated polyurethane polymer or a copolymer thereof, a non-fluorinated epoxy polymer or a copolymer thereof, a non-fluorinated polyimide (PI) polymer or a copolymer thereof, a non-fluorinated polyamide-imide polymer or a copolymer thereof, a non-fluorinated polyether-imide polymer or a copolymer thereof, a polyacrylate polymer or a copolymer thereof, or a combination thereof.

3. The non-fluorinated secondary battery of claim 2, wherein the non-fluorinated polyamide polymer comprises a sulfone-containing diamine monomer unit, a carboxylic acid-containing diamine monomer unit, and a monomer unit containing at least one aromatic ring.

4. The non-fluorinated secondary battery of claim 3, wherein the non-fluorinated polyamide polymer is a positive electrode binder, a negative electrode binder, a separator binder, or a bare area coating binder.

5. The non-fluorinated secondary battery of claim 1, wherein the negative electrode comprises a non-fluorinated polymer.

6. The non-fluorinated secondary battery of claim 5, wherein the non-fluorinated polymer comprises styrene-butadiene rubber (SBR) or a copolymer thereof, carboxymethyl cellulose (CMC) or a copolymer thereof, polyacrylic acid (PAA) or a copolymer thereof, a PAA metal salt (Metal-PAA) or a copolymer thereof, poly(vinyl acetate) or a copolymer thereof, poly(methacrylic acid) or a copolymer thereof, polymethyl methacrylate or a copolymer thereof, polymethacrylamide or a copolymer thereof, polyacrylonitrile (PAN) or a copolymer thereof, polymethacrylonitrile or a copolymer thereof, polyimide (PI) or a copolymer thereof, chitosan or a copolymer thereof, starch or a copolymer thereof, polyvinylpyrrolidone or a copolymer thereof, polyethylene or a copolymer thereof, polypropylene or a copolymer thereof, an ethylene-propylene-diene polymer (EPDM) or a copolymer thereof, a sulfonated-EPDM or a copolymer thereof, hydroxypropyl cellulose or a copolymer thereof, regenerated cellulose or a copolymer thereof, or a combination thereof.

7. The non-fluorinated secondary battery of claim 1, wherein the electrolyte of the non-aqueous electrolyte solution comprises a non-fluorinated lithium salt.

8. The non-fluorinated secondary battery of claim 7, wherein the non-fluorinated lithium salt comprises lithium perchlorate (LiClO₄), LiCl, LiBr, LiI, LiClO₄, LiB₁₀Cl₁₀, LiAlCl₄, LiSCN, LiC₄BO₈, LiCH₃SO₃, lithium chloroborane, lithium lower aliphatic carboxylate, lithium 4-phenyl borate imide, or a combination thereof.

9. The non-fluorinated secondary battery of claim 1, wherein the non-aqueous solution comprises vinylene carbonate, propylene sulfone, lithium bisoxalatoborate (LiBOB), N-methyl-2-pyrrolidone, propylene carbonate, ethylene carbonate, butylene carbonate, dimethyl carbonate, diethyl carbonate, ethyl methyl carbonate, gamma-butyrolactone, 1,2-dimethoxy ethane, 1,2-diethoxy ethane, tetrahydroxy franc, 2-methyl tetrahydrofuran, dimethyl sulfoxide, 1,3-dioxolane, 4-methyl-1,3-dioxene, diethyl ether, formamide, dimethylformamide, dioxolane, acetonitrile, nitromethane, methyl formate, methyl acetate, phosphoric acid triester, trimethoxy methane, a dioxolane derivative, sulfolane, methylsulfolane, 1,3-dimethyl-2-imidazolidinone, a propylene carbonate derivative, a tetrahydrofuran derivative, ether, methyl propionate, ethyl propionate, or a combination thereof.

10. A non-fluorinated polyamide polymer comprising:
a sulfone-containing diamine monomer unit, a carboxylic acid-containing diamine monomer unit, and a monomer unit containing at least one aromatic ring,
wherein the non-fluorinated polyamide polymer is a positive electrode binder, a negative electrode binder, a separator binder, or a bare area coating binder.
